(19) United States
(12) Patent Application Publication
(10) Pub. No.: US 2026/0069076 A1
(43) Pub. Date: Mar. 12, 2026

(54) Pour-Over Device

(71) Applicant: YETI Coolers, LLC, Austin, TX (US)

(72) Inventors: Dustin R. Bullock, Austin, TX (US); Daniel R. DiDomenico, Austin, TX (US)

(21) Appl. No.: 18/826,605

(22) Filed: Sep. 6, 2024

(51) Int. Cl. A47J 31/02

(52) U.S. Cl. CPC A47J 31/02

(57) ABSTRACT

Pour-over devices are described. The pour-over device may comprise double-walled construction. The pour-over devices may include a frustoconically shaped inner wall and a base. The frustoconically shaped inner wall may include a plurality of embossed ribs formed thereon. The frustoconically shaped inner wall may further include a plurality of venting transitions between the plurality of embossed ribs and substantially flat portions of the frustoconically shaped inner wall. The base may include a plurality of embossed ridges disposed therearound. The plurality of embossed ridges may include a first plurality of embossed ridges having a first height and a second plurality of embossed ridges having a second, different height. The base may further include an annular recess and a drip ledge disposed around a drip opening in the base.

### FIELD

The present disclosure relates generally to pour-over devices, and in particular, pour-over devices for brewed beverages.

### BACKGROUND

Beverages, such as coffee, are brewed and enjoyed the world over. The device used to brew the beverage may affect the final flavor profile and the convenience of the beverage preparation.

### SUMMARY

This Summary introduces a selection of concepts relating to this technology in a simplified form as a prelude to the Detailed Description that follows. This Summary is not intended to identify key or essential features.

Aspects of the present disclosure relate to pour-over devices, for example, for beverage brewing (e.g., coffee). The pour-over device may comprise a double-walled construction, for example, having an insulating gap between the double walls. The pour-over device may include a frustoconically shaped inner wall extending between a large opening and a small opening. The frustoconically shaped inner wall may be configured to accept a filter. The frustoconically shaped inner wall may include a plurality of embossed ribs formed thereon and distributed thereabout. The frustoconically shaped inner wall may further include a plurality of venting transitions between the plurality of embossed ribs and substantially flat portions of the frustoconically shaped inner wall. The venting transitions may be configured to allow airflow and/or venting between the frustoconically shaped inner wall and a filter (e.g., a wetted filter) placed therein. The pour-over device may further include a base. The base may be configured to rest on a rim of a beverage vessel. The base may include a plurality of embossed ridges disposed therearound. The plurality of embossed ridges may include a first plurality of embossed ridges having a first height and a second plurality of embossed ridges having a second, different height. The plurality of embossed ridges may enable venting of air and/or steam from the beverage vessel. The base may further include an annular recess and a drip ledge disposed around a drip opening in the base.

These and additional features will be appreciated with the benefit of the disclosures discussed in further detail below.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1 depicts an example pour-over device.

FIG. 2A depicts a top view of the example pour-over device of FIG. 1.

FIG. 2B depicts a cross-section view of an example rib and associated venting transitions of FIG. 2A.

FIG. 2C depicts a top view of an alternative example pour-over device.

FIG. 3 depicts a perspective bottom view of the example pour-over device of FIG. 1.

FIG. 4A depicts a bottom view of the example pour-over device of FIG. 3.

FIG. 4B depicts a cross-section view of an example base ridge of FIG. 4A.

FIG. 5 depicts a side view of an example pour-over device.

FIG. 6A depicts a cross-section of the example pour-over device of FIG. 1, taken along line A-A of FIG. 2A.

FIG. 6B depicts a cross-section of an example pour-over device, taken along line B-B of FIG. 2C.

Further, it is to be understood that the drawings may represent the scale of different components of various examples; however, the disclosed examples are not limited to that particular scale. Further, the drawings should not be interpreted as requiring a certain scale unless otherwise stated.

### DETAILED DESCRIPTION

In the following description of the various examples and components of this disclosure, reference is made to the accompanying drawings, which form a part hereof, and in which are shown by way of illustration various example structures and environments in which aspects of the disclosure may be practiced. It is to be understood that other structures and environments may be utilized and that structural and functional modifications may be made from the specifically described structures and methods without departing from the scope of the present disclosure.

Also, while the terms “front,” “top,” “base,” “bottom,” and “side” and the like may be used in this specification to describe various example features and elements, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of the claims.

In the following description, reference is made to one or more pour-over devices (e.g., pour-over dripper devices). Pour-over devices of the present disclosure may be constructed from various materials, including metals and/or alloys, for example, steel, tinplate steel, stainless steel, aluminum, titanium, and/or tin and combinations thereof. Additionally or alternatively, pour-over devices of the present disclosure may be constructed of other materials, including, for example, glass, ceramic, and/or polymeric material.

Pour-over devices may be used to brew beverages, for example, coffee. An example pour-over device may be configured to receive a filter. Beverage precursors, for example, coffee grounds, may be placed in the filter. Hot liquid (e.g., hot water) may be poured over the grounds. The hot liquid may extract flavors from the grounds and drip through the filter and pour-over device as described herein. The design of the pour-over device may affect numerous variables relating to ease of use, convenience of use, and the end product (e.g., the brewed beverage). For example, the design of the pour-over device may affect the flow rate of the liquid through the grounds; extraction time (e.g., the time the liquid is in contact with the coffee grounds); aeration (e.g., the amount of air that mixes with the coffee during brewing); maintained brew temperature; turbulence; liquid distribution (e.g., the distribution of the liquid over the coffee grounds); capacity; heat retention, packability, cleanability, etc. Additionally, the design of the pour-over device may lend itself to convenience or inconvenience. Accordingly, the structure and design of the pour-over device may play a substantial role in the usefulness of the device and in the finished beverage.

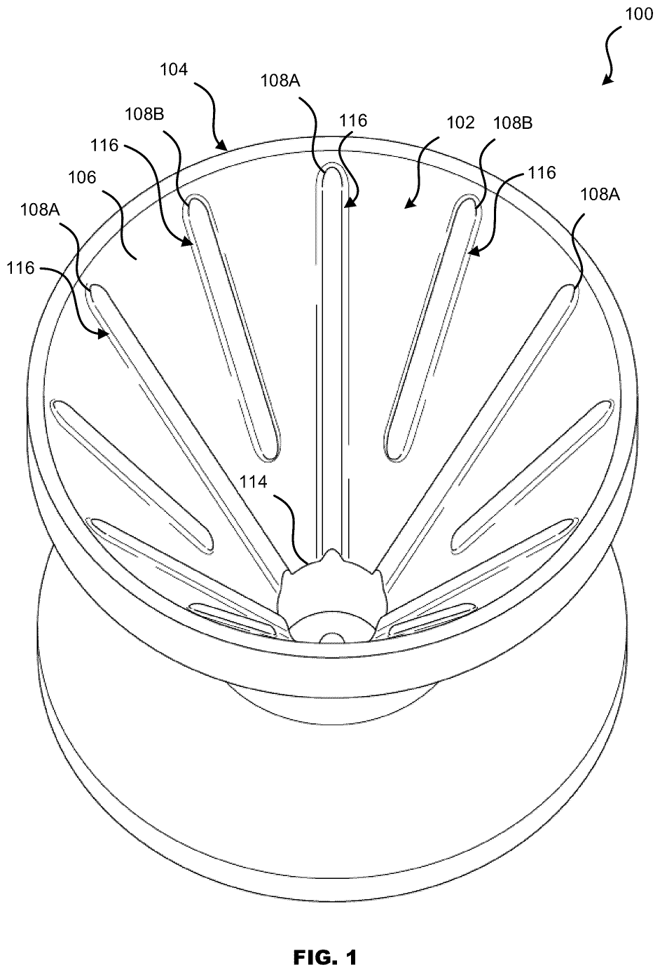

FIG. 1 depicts an example pour-over device 100. Referring to FIG. 1, The pour-over dipper 100 may comprise inner walls (and/or surfaces) and outer walls (and/or surfaces). The pour-over device 100 may comprise a substantially frustoconically shaped inner wall 102 (also referred to as, e.g., “inner wall 102” and “frustoconical inner wall 102”). The frustoconical shape may comprise a truncated cone shape, for example, resulting from a top portion (e.g., apex) of the cone being removed. The frustoconical inner wall 102 may comprise a first, large opening 104. The large opening 104 may be substantially circular or comprise an otherwise rounded shape. The frustoconical inner wall 102 may narrow, from the large opening 104, down toward a second, small opening 114. The frustoconical inner wall 102 may be defined as extending between the first, large opening 104 and the second, small opening 114.

The frustoconical inner wall 102 may be configured to accept a filter. The pour-over device 100 may accept filters of different shapes, sizes, and materials. For example, the pour-over device 100 may accept filters of paper, metal, cloth, plastic, ceramic, etc. A filter may be placed in the frustoconical inner wall 102 from the large opening 104. Beverage precursors (e.g., coffee grounds) may be placed in the filter. Liquid (e.g., hot water) may be poured over the beverage precursors. The liquid may mix with the beverage precursors and extract flavors and other compounds therefrom. Due to the conical shape of the frustoconical inner wall 102, the liquid with extracted material may drip through the small opening 114 into a below-situated collection vessel (as described in further detail herein). The configuration of the pour-over device 100 may affect, among other variables (as discussed herein), the drip-through rate or extraction time. Too long or too short extraction times may produce undesirable beverage flavors. For example, too long an extraction time (e.g., slow extraction and drip-through rate) may produce, for example, bitter beverage flavors. Conversely, too short an extraction time (e.g., quick extraction and drip-through) may produce, for example, weak beverage flavors. Accordingly, the flow rate and extraction time may affect the final beverage product.

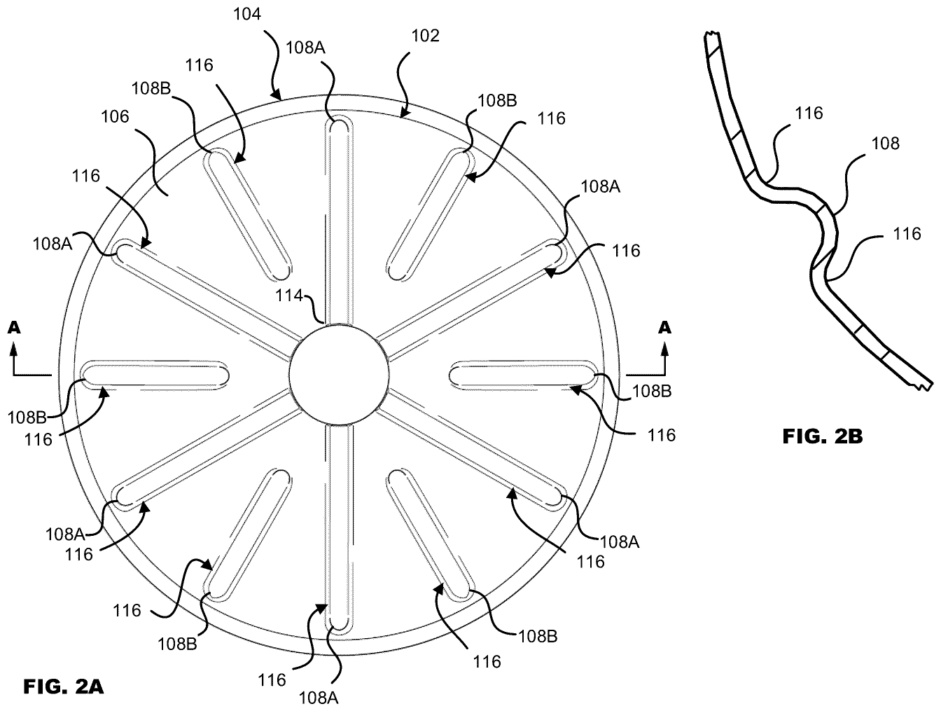

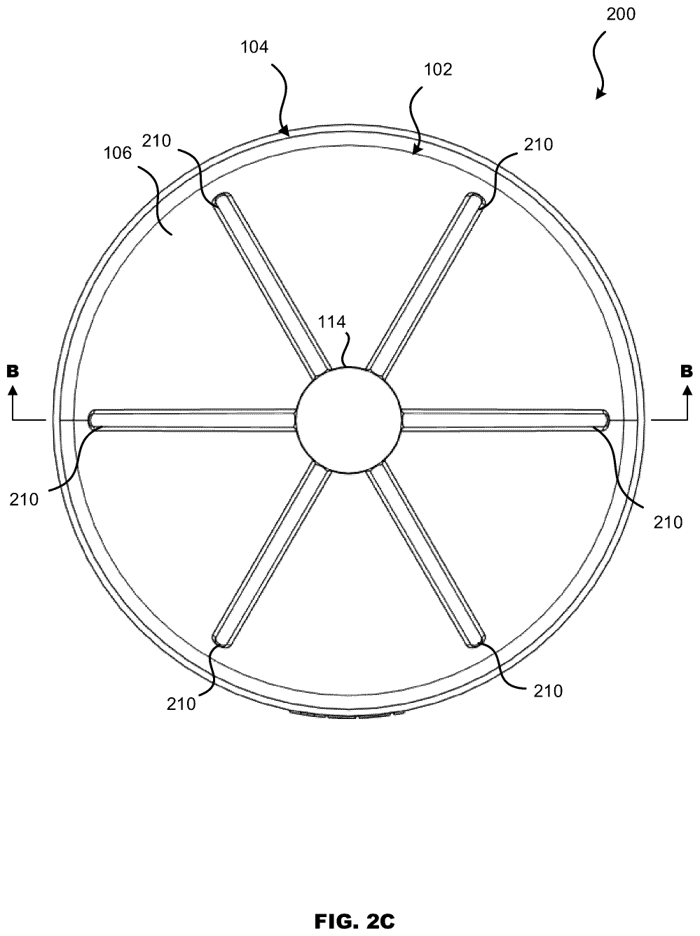

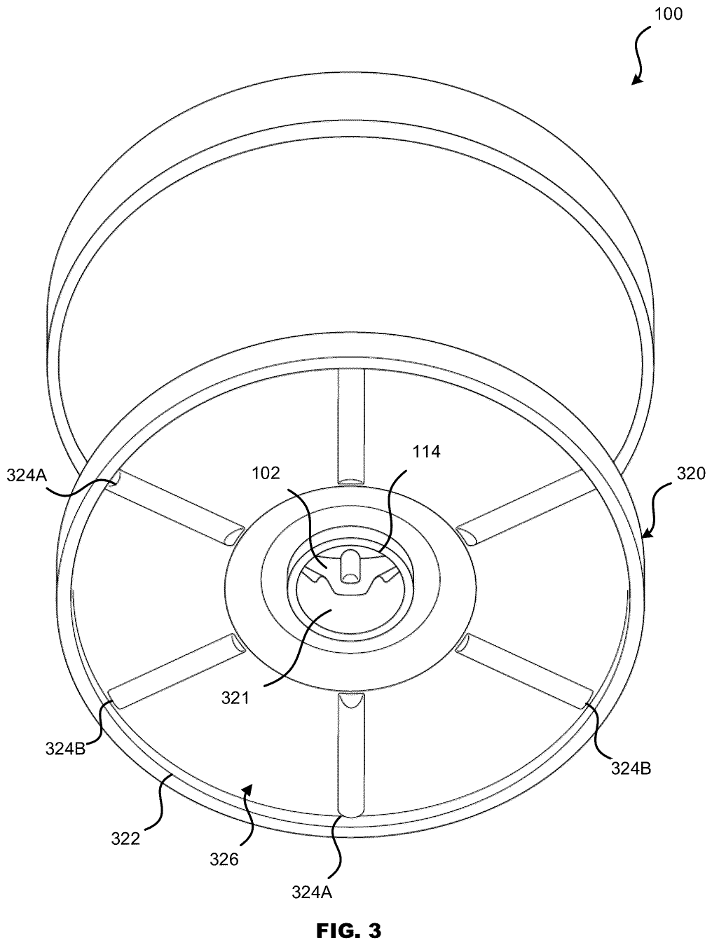

FIG. 2A depicts a top view of the example pour-over device 100. With reference to FIG. 1 and FIG. 2A, the frustoconical inner wall 102 may comprise substantially flat portions 106. The substantially flat portions 106 may be disposed between a plurality of ribs 108 (generally, plurality of ribs 108; particularly, first plurality of ribs 108A and second plurality of ribs 108B). The plurality of ribs 108 may be disposed and/or formed on the frustoconical inner wall 102. Each of the plurality of ribs 108 may comprise embossed elongations (e.g., embossed ribs). The plurality of ribs 108 may be embossed in relation to the substantially flat portions 106.

The plurality of ribs 108 may comprise a first portion of the plurality of ribs 108A (e.g., a first plurality of ribs 108A) and a second portion of the plurality of ribs 108B (e.g., a second plurality of ribs 108B). Each of the first plurality of ribs 108A may extend from the small opening 114 upward toward the large opening 104. Each of the first plurality of ribs 108 may extend substantially the majority of the way from the small opening 114 to the large opening 104. For example, in one example configuration, the first plurality of ribs 108 may extend about 95% of the distance between the small opening 114 and the large opening 104 along the frustoconical inner wall 102. Additionally or alternatively, in example configurations, the first plurality of ribs 108A may extend in a range of about 85% to about 100% of the distance between the small opening 114 and the large opening 104 along the frustoconical inner wall 102. Each of the first plurality of ribs 108 may extend substantially the entire length of the frustoconical inner wall 102. The pour-over device 100 may comprise six of the first plurality of ribs 108A and six of the second plurality of ribs 108B. As discussed further below, the inventors have appreciated the benefits of such an arrangement of the first plurality of ribs and the second plurality of ribs in providing a desirable extraction time. Alternatively, the pour-over device 100 may comprise more (e.g., 7, 8, 10, etc.) or less (e.g., 1, 2, 3, 4, 5) of the first plurality of ribs 108A and/or the second plurality of ribs 108B. It is also contemplated that the number of the first plurality of ribs 108A can be different than the number of the second plurality of ribs 108B. The first plurality of ribs 108A may be substantially uniformly distributed (e.g., substantially evenly spaced) around the frustoconical inner wall 102. The second plurality of ribs 108B may be substantially uniformly distributed (e.g., substantially evenly spaced) around the frustoconical inner wall 102. Each of the second plurality of ribs 108B may be shorter than each of the first plurality of ribs 108A. For example, in one example configuration, the second plurality of ribs 108B may extend about 70% of the distance between the small opening 114 and the large opening 104 along the frustoconical inner wall 102. Additionally or alternatively, in example configurations, the second plurality of ribs 108B may extend in a range of about 60% to about 80% of the distance between the small opening 114 and the large opening 104 along the frustoconical inner wall 102. The first plurality of ribs 108A and the second plurality of ribs 108B may be alternatively disposed around the frustoconical inner wall 102. Each of the second plurality of ribs 108B may be disposed between two neighboring of the first plurality of ribs 108A, and each of the first plurality of ribs 108A may be disposed between two neighboring of the second plurality of ribs 108B. The first plurality of ribs 108A and the second plurality of ribs 108B may terminate at about the same height on the frustoconical inner wall 102, for example, adjacent the large opening 104. In some embodiments, the second plurality of ribs 108B may extend between 40% and 70% of the distance between the small opening 114 and the large opening 104 along the frustoconical inner wall 102.

As described, the pour-over device 100 may be used with filters, (e.g., paper filters, v-60 filters, etc.). During the brewing process, the filter may be wetted with liquid. The wetted filter, or portions thereof, may adhere to surfaces of the pour-over device, for example, to portions of the frustoconical inner wall 102. The adhered filter may hinder airflow, for example, between the filter and the frustoconical inner wall 102. The adhered filter may slow the drip-through and extraction rates. Overly slow drip-through and extraction rates may cause the beverage to over-brew (e.g., become bitter, lose temperature, etc.) and cause an overly burdensome beverage preparation time requirement. It may be advantageous, therefore, to provide controlled venting between the filter and the pour-over device 100.

With continued reference to FIG. 1 and FIG. 2A, each of the plurality of ribs 108 (including, e.g., each of the first plurality of ribs 108A and each of the second plurality of ribs 108B) may comprise venting transitions 116. The venting transitions 116 may comprise portions of the frustoconical inner wall 102 between each of the ribs 108 and the proximate substantially flat portions 106. The venting transitions 116 may comprise a radius of curvature between each of the plurality of ribs 108 and the substantially flat portions 106. The venting transitions 116 may extend around substantially all of or a portion of each of the plurality of ribs 108A, 108B. The venting transitions 116 may be configured to disrupt the adherence of a filter (e.g., a wetted filter) to the frustoconical inner wall 102. The venting transitions 116 may be configured to enable airflow between a filter (e.g., a wetter filter) and the frustoconical inner wall 102. The venting transitions 116 associated with the first plurality of ribs 108A may extend into and terminate at the small opening 114, for example, enabling venting into the small opening 114. Accordingly, the venting transitions 116 may allow airflow between a filter and the pour-over device 100 and into a beverage vessel upon which the pour-over device 100 is placed.

While a lack of venting may burden (e.g., overly burden) the drip-through and extraction rates, too much venting between a filter and the pour-over device 100 may cause the liquid to drip through too quickly. Too quick drip-through and extraction rates may cause the beverage to under-brew (e.g., producing a weak beverage). The second plurality of ribs 108B and corresponding venting transitions 116 may provide additional venting. At least by virtue of the second plurality of ribs 108B terminating before the small opening 114, and by virtue of the second plurality of ribs 108B being shorter than the first plurality of ribs 108A, the second plurality of ribs 108B and corresponding venting transitions 116 may provide less venting than the first plurality of ribs 108A and corresponding venting transitions 116. With the ribs 108 and venting transitions 116 as described, the drip-through and extraction rates of the pour-over device may be improved and controlled.

FIG. 2B depicts a cross-section view of an example rib 108 and associated venting transitions 116 of FIG. 2A. The cross-section view of FIG. 2C is cropped for clarity. Referring to FIG. 2B, each of the plurality of ribs 108 (e.g., each of the first plurality of ribs 108A and the second plurality of ribs 108B) may comprise a substantially arcuate-shaped cross-section. In alternative example configurations, the ribs 108 may comprise otherwise shaped cross-sections. For example, the ribs 108 may comprise substantially square, triangular, or otherwise shaped cross-section. Additionally, as described, venting transitions 116 may be disposed between each of the ribs 108 and the proximate substantially flat portions 106 of the frustoconical inner wall 102. The venting transitions 116 may be rounded. The venting transitions 116 may comprise a radius of curvature configured to interrupt adherence of a filter (e.g., a wetted filter) to the frustoconical inner wall 102.

FIG. 2C depicts a top view of an alternative example pour-over device 200. As described, for example with reference to FIG. 2A, example pour-over devices may comprise ribs 108 and venting transitions 116. Additionally or alternatively, and referring to FIG. 2C, example pour-over device 200 may comprise alternatively configured venting features. For example, pour-over device 200 may comprise one or more (e.g. a plurality of) venting channels 210. The venting channels 210 may be configured on the pour-over device 200 substantially as described in relation to the ribs 108 (e.g., uniformly disposed around the frustoconical inner wall, having a first a second plurality of differing lengths, etc.) except as explicitly described.

The venting channels 210 may comprise debossed elongations on the frustoconical inner wall 102. The venting channels 210 may comprise substantially arcuate cross-sections. Alternatively, the venting channels 210 (or a portion thereof) may be alternatively shaped. For example, the venting channels 210 may comprise substantially square or triangular cross-sections. The venting channels 210 may extend into the small opening 114. The venting channels may be configured to provide venting between the frustoconical inner wall 102 and a filter (e.g., a wetted filter), for example, placed in the frustoconical inner wall 102. An example configuration comprising six venting channels 210 is depicted in FIG. 2C. It should be appreciated that alternative example configurations may comprise more (e.g., 7, 8, 9, 10, etc.) or less (e.g., 2, 3, 4, etc.) venting channels 210. Additionally or alternatively, similar to that which is described in relation to the first plurality of ribs 108A and the second plurality of ribs 108B, the pour-over device 200 may comprise a first plurality of venting channels and a second plurality of venting channels, wherein the first and second plurality of venting channels may be differently configured, for example, the first and second plurality of venting channels may comprise different lengths.

Referring to FIG. 1, the frustoconical inner wall 102 may comprise an apex angle or a cone angle. The apex angle may comprise the angle at which the cone widens. The apex angle may affect the drip-through rate and/or extraction time. In one example configuration, the frustoconical inner wall 102 may comprise an apex angle of about 60°, for example, between 55° and 65°. In alternative example configurations, the frustoconical inner wall 102 may comprise other apex angles (e.g., about 45° to about 75°).

Additionally or alternatively, the frustoconical inner wall 102 may comprise a height between the large opening 104 and the small opening 114. The frustoconical inner wall 102 height may be configured to be less than the height of a filter (e.g., a standardized filter). For example, the height of the frustoconical inner wall 102 may be between about 95 mm to about 115 mm. In other example configurations, the height of the frustoconical inner wall 102 may be larger or smaller. The height of the frustoconical inner wall 102 may be such that a portion of a filter (e.g., a standardized filter) extends above the top of the frustoconical inner wall 102. In this regard, a wetted filter, for example, after use, may be easily removed and discarded.

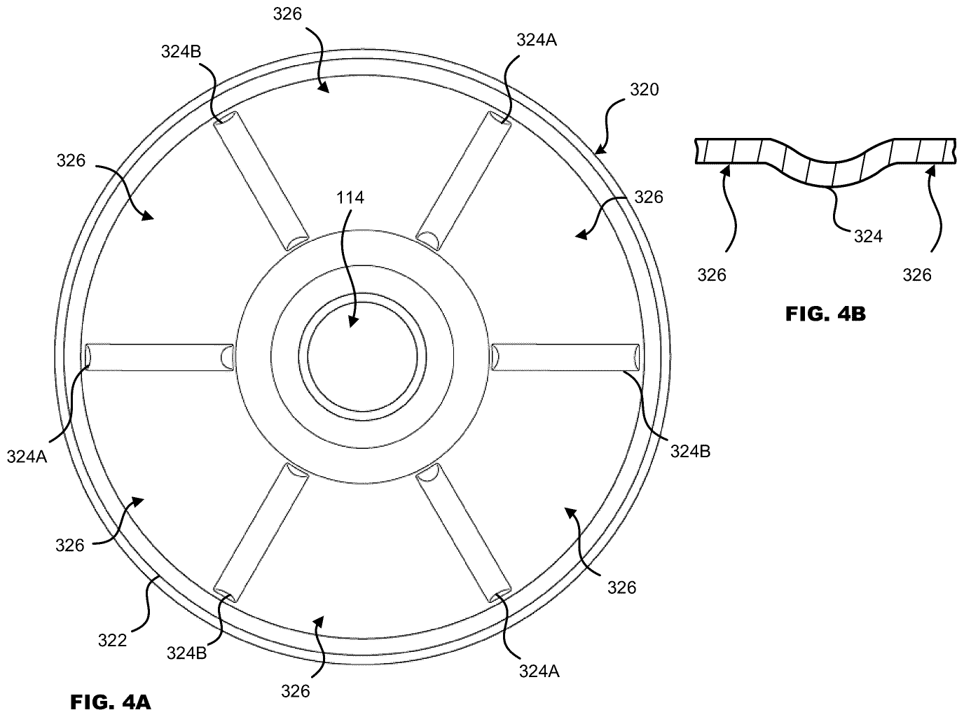

FIG. 3 depicts an alternate view of the example pour-over device 100. FIG. 4A depicts a bottom view of the example pour-over device 100. Referring to FIG. 3 and FIG. 4A, the pour-over device 100 may comprise a base 320. The base 320 may be substantially circular. The base 320 may be configured to rest on the rim of a beverage vessel (e.g., mug, tumbler, cup, thermos, etc.). The base 320 may be configured to rest on the rim of a beverage vessel such that the small opening 114 (e.g., drip hole) is positioned over a cavity of the beverage vessel. The small opening 114 may extend from the bottom of the frustoconical inner wall 102 through the base 320, for example, as a substantially cylindrical surface 321. The base 320 may comprise a lip 322. The lip 322 may extend from a perimeter or a portion of a perimeter of the base 320. The lip 322 may be configured to overhang a rim of a beverage vessel and/or to prevent the pour-over device 100 from sliding off of a beverage vessel upon which it is placed.

The base 320 may further comprise a plurality of base ridges 324 (also referred to as embosses or base ribs) (generally base ridges 324, particularly first base ridges 324A and second base ridges 324B). The plurality of ridges 324 may be disposed in a circular pattern around the circular base 320. The plurality of ridges 324 may be substantially uniformly distributed around the circular base 320. The base 320 may comprise substantially flat surface portions 326, for example, between the plurality of ridges 324. As described, in use, the pour-over device 100 may be placed on a rim of a beverage vessel. The plurality of ridges 324 may be configured to allow venting (e.g., of air, steam, etc.) from the underlying beverage vessel. For example, the plurality of ridges 324, or a portion thereof, may rest on the rim of the underlying beverage (e.g., drinkware) vessel. In this position, an air space or gap may exist between the substantially flat surface portions 326 of the base 320 and the rim of the underlying beverage vessel. The gaps may allow for venting of air and/or steam from the beverage vessel. For example, the beverage vessel may contain hot liquid, and/or the pour-over device 100 may be used to drip hot liquid into the beverage vessel (e.g., through small opening 114). The steam and/or hot liquid may cause a pressure buildup in the vessel (e.g., if the vessel was sealed). Additionally, as described, air-flow around the pour-over device 100 may be advantageous for desired operation of the pour-over device. Accordingly, venting from the beverage vessel may be advantageous for the operation of the pour-over device 100 (e.g., to control extraction and/or drip-through rates).

FIG. 4B depicts a cross-section view of an example base ridge of FIG. 4A. Referring to FIGS. 4A and 4B, the ridges 324 may be raised (e.g., embossed) from the base 320 surface (e.g., from the substantially flat surface portions 326). The ridges 324 may comprise a substantially arcuate cross-section. Alternatively, the ridges 324 may comprise a substantially flat surface (e.g., a substantially flat face surface). In one example configuration, each of the plurality of ridges 324 may be substantially identical in shape and height (e.g., about 1 mm in depth). According to some example configurations herein, the height of the ridges may be measured in a direction perpendicular to the base 320 surface.

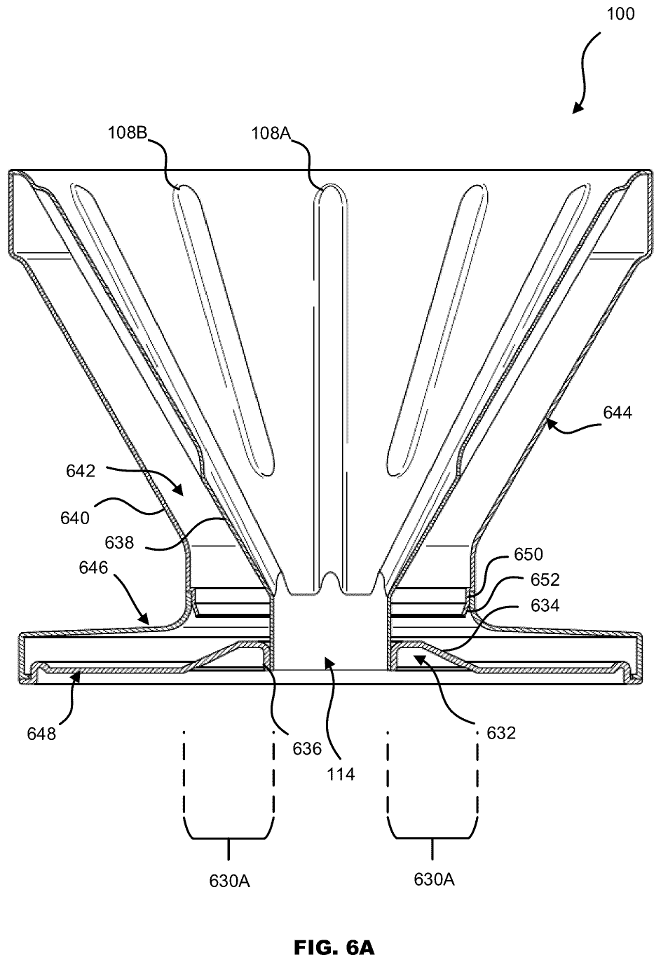

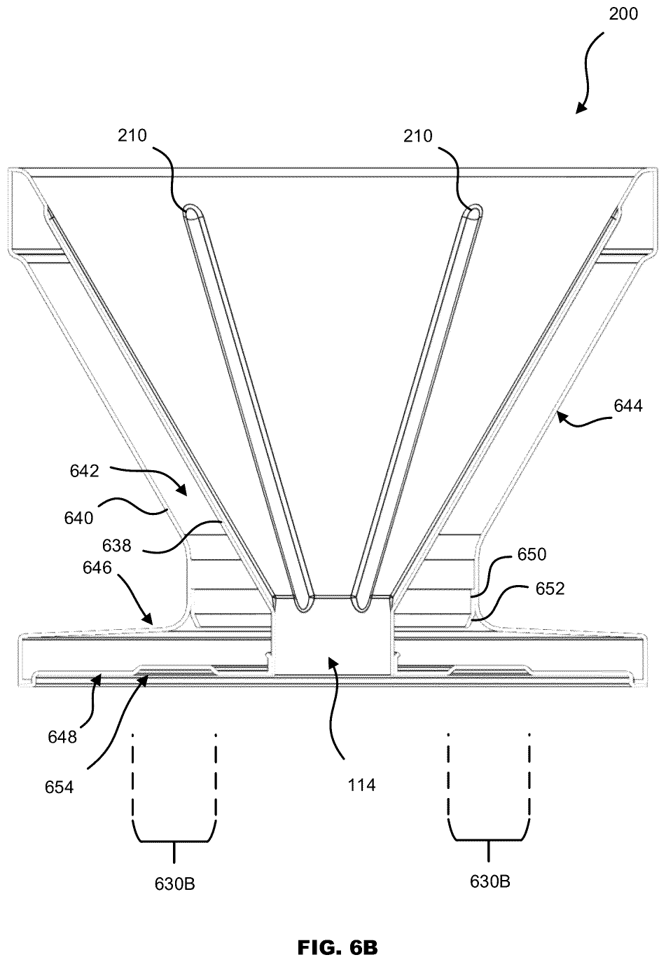

Alternatively, the plurality of ridges 324 may comprise a first plurality of ridges 324A (e.g., a first portion of the plurality of ridges 324) and a second plurality of ridges 324B (e.g., a second portion of the plurality of ridges 324). The first plurality of ridges 324A may comprise a first configuration, and the second plurality of ridges 324B may comprise a second configuration, different from the first configuration. For example, the first plurality of ridges 324A may have a first height (e.g., about 1 mm) from the substantially flat surface portions 326, and the second plurality of ridges 324B may have a second height (e.g., about 0.75 mm) from the substantially flat portions 326. The first plurality of ridges 324A may be considered proud in comparison to the second plurality of ridges 324B. The first plurality of ridges 324A and the second plurality of ridges 324B may comprise a height difference of about 0.25 mm to about 0.75 mm. The first plurality of ridges 324A and the second plurality of ridges 324B may be alternatingly disposed around the base 320. The pour-over device 100 may comprise six ridges 324. For example, the base 320 may comprise three of the first plurality of ridges 324A and three of the second plurality of ridges 324B. The three first plurality of ridges 324A may be substantially uniformly distributed around the base 320 surface and the three second plurality of ridges 324B may be substantially uniformly distributed around the base 320 surface. The first plurality of ridges 324A (e.g., the proud ridges) may provide stability for the pour-over device 100, for example, if the pour-over device 100 is resting on a rim of an underlying container. According to some example configurations, the inventors have appreciated that three proud ridges may provide enhanced stability regardless of the total number of ridges, as the three proud ridges provide three primary points of contact that will resist rocking of the pour-over device 100. In some other example configurations, the pour-over device 100 may comprise more (e.g., 7, 8, 9, 10, etc.) or less (e.g., 5, 4, 3, etc.) ridges 324. In different example configurations, ridges 324 may comprise different lengths. For example, the ridges may extend substantially between the lip 322 and an annular recess (e.g., as depicted and described with reference to FIG. 6A). Additionally or alternatively, the ridges 324 may be shorter. For example, the ridges 324 (or a portion thereof) may be disposed in the area of contact between the base and rim of an underlying beverage vessel.

Example venting features of the base 320 have been described as ridges 324, in other examples, the base can include inwardly extending or outwardly extending dimples, protuberances, projections, and combinations thereof in order to provide one or more gaps between the vessel and the pour-over device so as to provide for airflow between the rim of the vessel and the base. It is also contemplated that the base may include a texture or portions with a texture applied so as to provide for airflow between the rim of the vessel and the base. According to example configurations herein, the inventors have appreciated the benefits of radially extending ridges 324 that may be configured to support the pour-over device 100 on a variety of different vessels having different diameters.

FIG. 3, FIG. 4A, and FIG. 4B depict an example configuration in which ridges 324 are embossed from the substantially flat portions 326. In other example configurations, venting features may be debossed from the substantially flat surface portions 326. For example, such debossed venting features may comprise one or more channels or cavities. In such example configurations, in use, the substantially flat surface portions 326 may rest on the rim of an underlying beverage vessel, and the debossed features (e.g., debossed arcuate features) may allow venting from the beverage vessel. It is contemplated that differently configured venting features (e.g., ridges 325 and channels) may be used in combination.

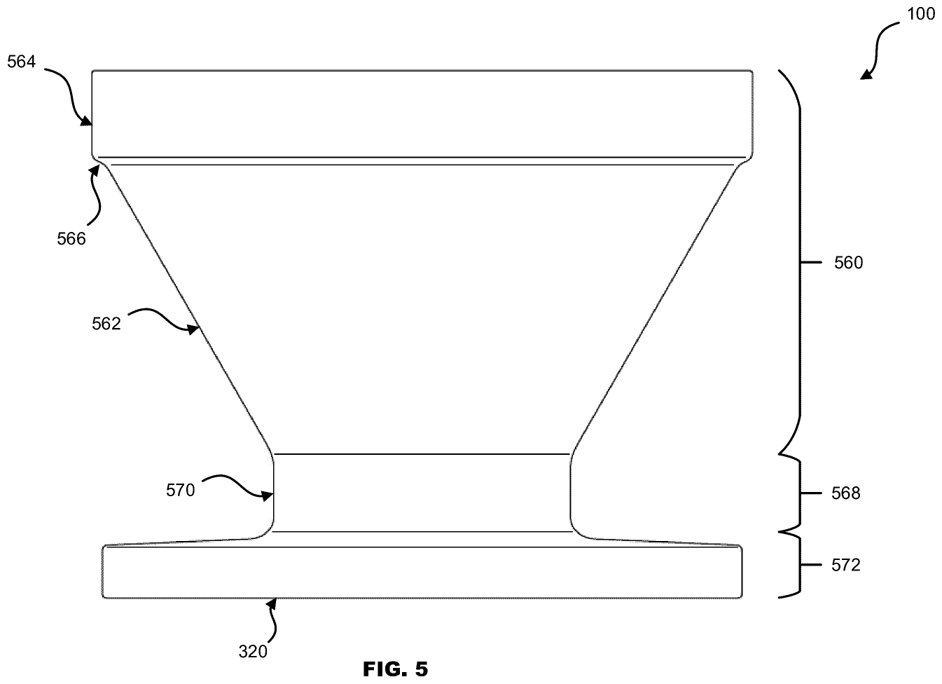

FIG. 5 depicts a side view of an example pour-over device 100. Referring to FIG. 5, the pour-over device 100 may be defined by regions. The pour-over device 100 may comprise a top region 560. The top region 560 may comprise a frustoconical outer surface 562. The frustoconical outer surface 562 may be disposed opposite a portion of the frustoconical inner wall 102 (e.g., as depicted in FIGS. 6A and 6B). The top region 560 may terminate, at a top portion thereof, in a cylindrical ring 564. The cylindrical ring 564 may be connected to the frustoconical outer surface 562 by a ridge 566. The ridge 566 and/or the cylindrical ring 564 may be configured to assist a user in holding/gripping the pour-over device 100.

Below the top region 560, the pour-over device 100 may comprise a middle region 568. The middle region 568 may comprise a neck 570. The neck 570 may extend (e.g., downward) from the frustoconical outer surface. Below the middle region, the pour-over device 100 may comprise a base region 572. The base region 572 may comprise the base 320 (e.g., as depicted in FIGS. 3 and 4). The pour-our device 100 may be substantially uniform around its perimeter.

FIG. 6A depicts a cross-section of an example pour-over device 100, taken along line A-A of FIG. 2A. Referring to FIG. 6A, the pour-over device 100 may comprise a drip region 630A (generally, drip region 630). The inventors have appreciated that liquid adhering to and traveling across the bottom surface of a base may ultimately run to an interface between a beverage vessel rim and a pour-over device and may run over the edge of the beverage vessel rim. At such an interface, such liquid may run undesirably down the outside of the beverage vessel and cause spillage. Accordingly, the drip region 630A may be configured to limit (e.g., inhibit, impede) liquid from adhering to and traveling (e.g., running) across the surface of the base 320 in the pour-over device 100.

The drip region 630A may comprise an annular recess 632. The annular recess 632 may comprise a recessed portion (e.g., a recessed annular portion) of the surface of the base 320 around the small opening 114. The annular recess 632 may be radially spaced from and/or proximate to (e.g., near or immediately adjacent) the small opening 114. The annular recess 632 may comprise a first recess transition 634 from the bottom surface of the base 320. The first recess transition 634 may comprise a sloped surface extending from the bottom surface of the base 320 into the annular recess 632. Alternatively, the first recess transition 634 may be substantially vertical (e.g., as opposed to sloped) or having a relatively small draft angle. The drip region 630A may further comprise a second recess transition comprising a drip ledge 636. The drip ledge 636 may comprise a surface extending from the annular recess 632 downward (e.g., toward an underlying beverage vessel, e.g., in use). The drip ledge 636 may extend lower than the annular recess. The drip ledge 636 may be substantially vertical or comprise a relatively small draft angle. The drip ledge 636 may comprise a bottom wall portion of the small opening 114. The pour-over device 100 may comprise a relatively abrupt transition between the annular recess 632 and the drip ledge 636. Additionally or alternatively, the pour-over device 100 may comprise a relatively abrupt transition between the drip ledge 636 and the small opening 114. The configuration of the drip region 630A may cause liquid to drip from the small opening 114 and/or drip ledge 636 instead of (e.g., as opposed to) adhering to the bottom surface of base 320. With the increased impetus for the liquid to drip from the drip ledge 636 instead of running across the surface of the base 320, the pour-over device 100 may avoid spillage of any liquid exiting the small opening 114.

With continued reference to FIG. 6A, the pour-over device 100 may comprise double-walled construction. For example, the pour-over device 100 may comprise double-walled steel construction, which in certain examples can be stainless steel. Accordingly, all regions of the pour-over device 100 may comprise a first wall 638 (e.g., inner wall) and an opposing second wall 640 (e.g., outer wall). The first wall 638 and the opposing second wall 640 may be differently or similarly shaped. The first wall 638 and opposing second wall 640 may be spaced apart. The first wall 638 and opposing second wall 640 may define an inner space 642 (e.g., a gap) therebetween. The inner space 642 may be filled with air (e.g., forming an insulating air gap). Alternatively, the inner space 642 may be vacuumed (e.g., forming an insulating vacuumed gap). Such a double-walled construction may improve the insulating properties of the pour-over device 100. These insulating properties may be advantageous as the pour-over device 100 may be used to brew hot beverages. The improved insulating properties of the example double-walled pour-over device 100 may allow the pour-over device 100 to be handled without a handle, and may allow the pour-over device 100 to forgo a handle, for example, extending from an external surface, while maintaining the handleability of the pour-over device 100 even when containing hot contents. Being able to forgo a handle may improve the compactness and uniformity of the pour-over device 100, resulting in a pour-over device that has improved packability (e.g., in a travel bag, dishwasher, etc.) and storability. Additionally or alternatively, the improved insulating properties of the example double-walled constructed pour-over device 100 may improve the maintenance of beverage temperature brewed in the pour-over device 100.

In an example configuration, a vacuum may be pulled on the inner space 642 (e.g., between the first wall 638 and the second wall 640). Formation of a vacuum of the inner space 642 may be substantially as described in co-owned U.S. application Ser. No. 15/285,268, filed on Oct. 4, 2016, and titled Container and Method of Forming a Container (the “'268 Application”), which is incorporated herein by reference in its entirety and for all purposes. Forming a vacuum in the inner space 642 may further improve the insulating properties of the pour-over device 100. A vacuum may be pulled on the inner space 642, for example, as described in the '268 Application, on one or more parts or surfaces of the pour-over device 100. For example, in one example configuration and method, a vacuum may be pulled on the inner space 642 on the third part 648, for example, on one or more of the substantially flat surface portions 326 (e.g., depicted in FIG. 4A).

With continued reference to FIG. 6A, the pour-over device 100 may be constructed of multiple parts. For example, the pour-over device 100 may be constructed of multiple parts of stamped steel, which again can be stainless steel in certain examples. For example, a first part 644 may comprise the small opening 114, the frustoconical inner wall 102, the cylindrical ring 564, the frustoconical outer surface 562, and a portion of the neck 570. A second part 646 may comprise a portion of the neck 570 and a portion of the base region 572. A third part 648 may comprise a second portion of the base region 572. The multiple pieces may be assembled to form the pour-over device 100. For example, the multiple pieces, or portions thereof, may be welded, for example, Tungsten Inert Gas (TIG) welded, Metal Inert Gas (MIG) welded, laser welded, resistance welded, plasma arc welded, ultrasonic welded, friction stir welded, etc.

The various pieces may be formed to accommodate the assembly (e.g., welding). For example, referring to FIG. 6A, butt welding may produce an inferior joint. Therefore, it may be disadvantageous to join pieces via butt welding. One or more of the pieces may be formed to avoid butt welding. For example, the first part 644 may be formed with an internal ledge 650 and flair 652. For fabrication, the second part 646 may be placed together with the first part 644. In doing so, the flair may be inserted into an opening of the second part 646. This may facilitate easy installation and alignment of the first and second parts. Additionally, the second part 646 may be welded to the first part 644 at the ledge, avoiding a disadvantageous butt joint and producing a more advantageous (e.g., stronger) lap joint.

FIG. 6B depicts a cross-section of an example pour-over device 200, taken along line B-B of FIG. 2C. Referring to FIG. 6B, whereas the example pour-over device 100 of FIG. 6A depicts ribs 108A and 108B, the example pour-over device 200 of FIG. 6B depicts venting channels 210. Additionally or alternatively, the drip region 630, for example, as described in FIG. 6A, may be alternatively configured. For example, and referring to FIG. 6B, the drip region 630B may comprise substantially uniform annular recess 654. The substantially uniform annular recess 654 may comprise a recess in a portion of the base. The substantially uniform annular recess 654 may be radially spaced from and/or proximate to (e.g., adjacent) the small opening 114. Alternatively the substantially uniform annular recess 654 may be elsewhere disposed along the circular base.

The present disclosure is disclosed above and in the accompanying drawings with reference to a variety of examples. The purpose served by the disclosure, however, is to provide examples of the various features and concepts related to the disclosure, not to limit the scope of the disclosure. One skilled in the relevant art will recognize that numerous variations and modifications may be made to the examples described above without departing from the scope of the present disclosure.

What is claimed is:

1. A device comprising:
a substantially frustoconically shaped inner wall comprising a first opening and a second opening larger than the first opening;
a first plurality of ribs formed on and distributed around the frustoconically shaped inner wall, each of the first plurality of ribs extending from the first opening toward the second opening;
a second plurality of ribs formed on and distributed around the frustoconically shaped inner wall, each of the second plurality of ribs being shorter than the first plurality of ribs, wherein the first plurality of ribs and the second plurality of ribs are alternatingly disposed around the frustoconically shaped inner wall;
a plurality of venting transitions between each of the first and second pluralities of ribs and flat portions of the frustoconically shaped inner wall;
a base configured to be placed on a drinkware vessel; and
an outer wall spaced apart from the frustoconically shaped inner wall to form a double-walled construction having an insulating gap between the outer wall and the frustoconically shaped inner wall.

2. The device of claim 1, wherein the frustoconically shaped inner wall comprises an apex angle of about 60 degrees.

3. The device of claim 1, wherein the first plurality of ribs and the second plurality of ribs are substantially uniformly distributed around the frustoconically shaped inner wall.

4. The device of claim 1, wherein the base further comprises:
a plurality of base ridges from the base and uniformly distributed in a circular pattern around the base, a first portion of the plurality of base ridges comprising a first height and a second portion of the plurality of base ridges comprising a second, different height, wherein the base ridges are distributed in an alternating pattern between base ridges of the first portion and base ridges of the second portion.

5. The device of claim 1, wherein the base is further configured such that upon placement of the base on the drinkware vessel, one or more air gaps are formed between a rim of the drinkware vessel and the base.

6. The device of claim 4, wherein the first height and the second height differ between about 0.25 mm to about 0.5 mm.

7. The device of claim 1, wherein each of the first plurality of ribs and the second plurality of ribs comprise an arcuate-shaped cross section.

8. The device of claim 1, wherein the venting transitions comprise a radius of curvature transitioning between each of the plurality of ribs and substantially flat portions of the frustoconically shaped inner wall.

9. The device of claim 1, wherein the venting transitions are configured to provide air flow between the frustoconically shaped inner wall and a wetted filter disposed therein.

10. The device of claim 1, wherein the base further comprises:
an annular recess, in the base, proximate to the first opening, the annular recess and the first opening forming a drip ledge around a perimeter of the first opening extending beyond the annular recess, the drip ledge being configured to impede adherence of liquid to a surface of the base.

11. A device comprising:
a substantially frustoconically shaped inner wall comprising a first opening and a second opening larger than the first opening;
a plurality of ribs formed on and distributed around the frustoconically shaped inner wall; and
a base extending from the first opening and configured to rest on an opening of a drinkware vessel, the base comprising a plurality of base ridges distributed in a circular pattern around the circular base, wherein the plurality of base ridges comprise a first plurality of base ridges comprising a first height and a second plurality of base ridges comprising a second height, wherein the first height is different from the second height.

12. The device of claim 11, wherein the plurality of base ridges are further distributed around the base in an alternating pattern between the first height and the second height.

13. The device of claim 11, wherein the first height and second height differ between about 0.25 mm to about 0.5 mm.

14. The device of claim 11, wherein each of the plurality of base ridges comprise a substantially arcuate-shaped cross section.

15. The device of claim 11, further comprising:
a plurality of venting transitions each disposed between a rib of the plurality of ribs and a proximate substantially flat portion of the frustoconically shaped inner wall.

16. The device of claim 11, wherein the base further comprises:
an annular recess proximate to the base opening; and
a drip ledge around a perimeter of the base opening and extending beyond the annular recess.

17. A device comprising:
a substantially frustoconically shaped inner wall comprising a first opening and a second opening larger than the first opening;
a plurality of ribs formed on and distributed around the frustoconically shaped inner wall;
a base configured to rest on an opening of a drinkware vessel, the base comprising:
the first opening; and
a plurality of base ridges distributed around the base; and
an annular recess in the base proximate to the first opening, the annular recess and the first opening forming a drip ledge, around a perimeter of the first opening, and extending beyond the annular recess.

18. The device of claim 17, wherein the drip ledge is configured to impede liquid adherence to a bottom surface of the base.

19. The device of claim 17, further comprising a plurality of venting transitions each disposed between a rib of the plurality of ribs and a proximate substantially flat portion of the frustoconically shaped inner wall.

20. The device of claim 17, wherein the base further comprises:
a plurality of base ridges from the base and distributed in a circular pattern around the base, the plurality of base ridges comprising a first plurality of base ridges comprising a first height and a second plurality of base ridges comprising a second height different from the first height.

21. An device comprising:
an inner wall and an outer wall and wherein the inner wall and the outer wall are spaced apart to define an insulating gap between the inner wall and the outer wall;
a first opening and a second opening, wherein the second opening is larger than the first opening;
a plurality of venting transitions positioned on the inner wall, wherein the plurality of venting transitions are configured to provide spacing between the inner wall and a filter; and
a base configured to rest on an opening of a drinkware vessel and to provide one or more vents between a rim of the drinkware vessel and a bottom surface of the base.

22. The device of claim 21, wherein the inner wall comprises a plurality of ribs and the plurality of ribs define the plurality of venting transitions.

23. The device of claim 21, wherein the base comprises one or more projections to create the one or more vents.

24. The device of claim 21, wherein the base further comprises: an annular recess proximate to the first opening; and a drip ledge around a perimeter of the first opening and extending lower than the annular recess.
